(19) United States
(12) Patent Application Publication
(10) Pub. No.: US 2020/0099054 A1
(43) Pub. Date: Mar. 26, 2020

(54) MULTI-LAYERED GRAPHENE MATERIAL HAVING A PLURALITY OF YOLK/SHELL STRUCTURES

(71) Applicant: SABIC Global Technologies B.V., Bergen op Zoom (NL)

(72) Inventors: Yunyang LIU, Thuwal (SA); Ihab N. ODEH, Sugar Land, TX (US)

(21) Appl. No.: 16/471,722

(22) PCT Filed: Jan. 24, 2018
(86) PCT No.: PCT/US2018/014979

§ 371 Date: Jun. 20, 2019

Related U.S. Application Data
(60) Provisional application No. 62/449,752, filed on Jan. 24, 2017.

(51) Int. Cl. H01M 4/62; H01M 4/36; H01M 4/38; H01M 4/58; H01M 4/1397; H01M 10/0525; H01M 4/136; C01B 32/194; C01B 32/184

(52) U.S. Cl. CPC H01M 4/625; H01M 4/366; H01M 4/38; H01M 4/5815; H01M 4/1397; C01B 2204/22; H01M 4/136; C01B 32/194; C01B 32/184; C01B 2204/04; H01M 10/0525

(57) ABSTRACT

Multi-layered graphene materials and methods of making and using the same are described herein. A multi-layered graphene material can include at least two graphene layers that are attached to one another and have a plurality of yolk-shell type structures retained within a plurality of spaces between the graphene layers. Each yolk/shell type structure can include an elemental sulfur nano- or microstructure yolk and a carbon-containing porous shell. The yolk-shell structure has a volume sufficient to allow for volume expansion of the elemental sulfur nano or microstructure without deforming the multi-layered graphene structure.

### CROSS REFERENCE TO RELATED APPLICATIONS

This application claims the benefit of priority of U.S. Provisional Patent Application No. 62/449,752 filed Jan. 24, 2017, which is hereby incorporated by reference in its entirety.

### BACKGROUND OF THE INVENTION

### A. Field of the Invention

The invention generally concerns a multi-layered graphene material that includes at least two graphene layers attached to one another and has a plurality of spaces between the layers with a plurality of yolk-shell structures retained in said spaces. Each yolk/shell like structure includes an elemental sulfur nano- or microstructure and a carbon-containing porous shell.

### B. Description of Related Art

The increasing energy demand and environmental concerns have caused a need for environmentally friendly energy storage systems that are safe and low cost and have high energy densities. To meet this need, lithium-sulfur (Li—S) batteries have been developed as they (1) have a high theoretical capacity of 1672 mAh g⁻¹, which is over 5 times that of currently used transition metal oxide cathode materials, (2) are relatively inexpensive to manufacture due to abundant resources of sulfur, and (3) have nonpoisonous and environmentally benign characteristics. However, the practical application of Li—S battery cells is still limited by the following drawbacks: (1) poor electrical conductivity of sulfur (5×10⁻³° S cm⁻¹) limits the utilization efficiency of active material and rate capability; (2) high solubility of polysulfide intermediates in the electrolyte results in a shuttling effect in the charge-discharge process; and (3) large volumetric expansion (about 80%) during charge and discharge, which results in rapid capacity decay and low Coulombic efficiency.

The high capacity and cycling ability of sulfur can arise from the electrochemical cleavage and re-formation of sulfur-sulfur bonds in the cathode, which, without wishing to be bound by theory, is believed to proceed in two steps. First, the reduction of sulfur to lithium higher polysulfides (Li₂Sₙ where 4≤n≤8) is followed by further reduction to lithium lower polysulfides (Li₂Sₙ where 1≤n≤3). The higher polysulfides can be dissolved into the organic liquid electrolyte, enabling them to penetrate through a polymer separator between the anode and cathode, and then react with the lithium metal anode, leading to the loss of sulfur active materials. Even if some of the dissolved polysulfides diffuse back to the cathode during the recharge process, the sulfur particles formed on the surface of the cathode are electrochemically inactive owing to the poor conductivity. Such a degradation path leads to poor capacity retention, especially during long cycling (e.g., more than 100 cycles).

Various attempts to improve Li—S battery cells while inhibiting polysulfide dissolution and shuttling have been described. By way of example, Seh et al. (Nat. Commun. 2013, 4:1331) describes the use of sulfur@TiO₂ yolk-shell nanoparticles, in a cathode for Li—S batteries to address polysulfide dissolution. Hou et al. (Nanoscale, 2016, 8:8228) describes confining sulfur in a 2D carbon nanosheet with a porous structure followed by 3D aerogel wrapping. In yet another example, Zhou et al. (Advanced Energy Materials, 2015, 5, 1402263) describes a graphene sulfur composite that includes sulfur@nitrogen double shelled carbon spheres intercalated into graphene powder. International Patent Application Publication No. WO 2015/103305 to Cairns et al. describes a Li₂S material coated with a conductive carbon based polymer for use in lithium-sulfur batteries or lithium ion batteries. International Application Publication No. WO 2014/082296 to Wang et al. describes a cathode material for a Li—S battery that includes spherical dehydrogenized acrylonitrile-based polymer coated graphene particles having sulfur particles embedded in the polymer surface.

Despite all of the currently available research on graphene materials for use in Li—S battery cells, many of these materials suffer from capacity degradation during charge-discharge cycles and only allow two-dimensional (2D) expansion of intercalated nanoparticles. Further, the continuous expansion/de-expansion cycle during lithiation and delithiation leads to structural failure of the graphene layers and ultimately battery failure. In addition, many of these systems suffer from complex and non-environmentally friendly manufacturing protocols, low active material loading, and decreased electronic conductivity contributing to overall unsatisfactory electrochemical performances.

### SUMMARY OF THE INVENTION

A solution to the problems associated with expansion and de-expansion of graphene materials and the shuttling effect seen with polysulfides has been discovered. The solution lies in the ability to design a graphene material that allows for the absorption of metal ions (e.g., lithium ions) with limited to no corresponding expansion of the graphene material while inhibiting or substantially inhibiting polysulfide dissolution. In particular, an elemental sulfur yolk/porous carbon-containing shell-type architecture is introduced into the graphene material, where the nano- or microstructured elemental sulfur yolk can absorb metal ions (e.g., Li ions) and expand without causing the graphene material to expand. In preferred instances, the elemental sulfur yolk is a nanostructured yolk/nano-sized. The graphene material includes at least two graphene layers that are attached to one another having a plurality of intercalated yolk-shell nano- or microstructures and a void space around each intercalated nano- or microstructure. In some embodiments, at least two of the graphene materials are attached to one another through a carbon material formed from the carbonization of a carbon containing polymer. In other embodiments, at least two of the graphene materials are attached through physical forces. The carbonized material, in certain aspects, includes at least 95 wt. % carbon, preferably 99 wt. % carbon, or more preferably 100 wt. % carbon. This structure results in a graphene material having a multitude of yolk/double shell type structures, where the elemental sulfur yolk is a nano- or microstructure and a first shell is a porous carbon-containing shell. In some embodiments, the yolk is a composite that includes a metal oxide and sulfur (e.g., a TiO₂—S composite). At least portions of the carbon containing shell are surrounded by at least two graphene layers that can act a second shell. This configuration allows for the three dimensional expansion of the elemental sulfur nano- or microstructure in the hollow space of the yolk-carbon shell structure, thus reducing or avoiding expansion of the graphene material and ultimately lowering or eliminating damage to the graphene material. This is in contrast to 2D expansion typically associated with graphene materials such as those used in energy storage applications. In addition, the graphene material of the present invention can capture produced polysulfides, specifically, higher order polysulfides (Li₂Sₙ, where 4≤n≤8), thereby reducing the polysulfide shuttling effect seen with existing technologies. Also, the graphene material of the present invention has increased cyclability when compared with existing technologies. This makes the graphene materials of the present invention suitable for a wide-range of applications, preferably for use in energy devices (e.g., lithium batteries, capacitors, supercapacitors and the like, preferably a lithium-sulfur secondary battery).

In one particular embodiment, a multi-layered graphene material is described. The multi-layered graphene material can include at least two of graphene layers (e.g., graphene oxide layers) having a plurality spaces between the layers. A plurality of yolk-shell structures can be positioned within the plurality of spaces. Each yolk-shell structure can include an elemental sulfur nano- or microstructure, a polysulfide trapping agent or metal oxide/sulfur composite, and a carbon-containing porous shell with an exterior surface and an interior surface that defines and encloses a hollow space within the interior of the shell where the elemental sulfur nano- or microstructure can be included in the hollow space. The carbon-containing porous shell can be electrically conductive. In some instances, the carbon-containing porous shell is a single shell. In another instance, the yolk-shell structure does not include a double shell where an outer metal-oxide shell encompasses the carbon-containing shell that encompasses the yolk. The plurality of spaces between the at least two graphene layers are configured to retain the plurality of yolk-shell structures. At least two of the graphene layers are attached to one another through a carbon material comprising at least 95 wt. % carbon, preferably 99 wt. % carbon, or more preferably 100 wt. % carbon and/or through a plurality of separate attachment points. In some instances, the carbon material that forms the attachment and the carbon-containing porous shell are both derived from the same material, preferably a carbon-containing polymer. The carbon-containing porous shell and/or attachment material can include nitrogen or a nitrogen containing compound. The hollow space with the carbon shell that comprises the sulfur nano- or microstructure has a volume sufficient to allow for volume expansion (e.g., at least 50% volume expansion, at least 80% volume expansion, or 50% to 500% volume expansion) of the at least one of the plurality of sulfur nano- or microstructures without deforming the shell-like structure. In some embodiments, the multi-layered graphene material can include a polysulfide trapping agent. Polysulfide trapping agents can be embedded in the carbon-containing porous shell, in contact with the interior surface of the carbon-containing porous shell, included in the hollow space, include in the yolk, and/or in contact with the elemental sulfur containing nano- or microstructure, or any combination thereof. In some instances the polysulfide trapping agent is included in the sulfur precursor material (e.g., a composite material). In some instances, the polysulfide trapping agent can include a metal oxide. Metal oxides can include magnesium oxide (MgO), alumina (Al₂O₃), ceria (CeO₂), lanthanum oxide (La₂O₃), tin oxide (SnO₂), titanium oxide (e.g., Ti₄O₇ in the Magnéli phase), titanium dioxide (TiO₂), manganese dioxide (MnO₂), or calcium oxide (CaO), or any combination thereof). In one embodiment, the elemental sulfur containing nano- or microstructure is a TiO₂—S composite. The graphene material can be formed into a sheet or a film, and, in some instances, the sheet or film can have a thickness of 10 nm to 500 μm. In some instances, the multi-layered graphene material is binder free.

In another instance, an energy device that includes the multi-layered graphene material of the present invention is described. The energy device can be a rechargeable battery (e.g., a lithium-ion or lithium-sulfur battery). An electrode (e.g., a cathode and/or an anode) of the battery can include the multi-layered graphene material.

Methods of making the multi-layered graphene material of the present invention are also described. One method can include obtaining a composition that includes a carbon-containing organic polymer, a plurality of graphene or graphene oxide layers, and a plurality of metal sulfide nano- or microstructures or a composition that includes a plurality of graphene or graphene oxide layers, and a plurality of metal sulfide containing nano- or microstructures having an organic polymer coating. A multi-layered graphene precursor material can be formed from the composition by heat treating the multi-layered graphene precursor material to convert any graphene oxide layers to graphene. Heat treating can also form carbon-containing porous shells from the shells that include the carbon-containing polymer precursor. In some embodiments, heat treating can form at least one carbon-containing attachment point between the at least two graphene layers from the carbon-containing organic polymer. The precursor material can include at least two graphene or graphene oxide layers that are attached to one another through the carbon-containing organic polymer, where a plurality of spaces are present between the layers, and a plurality of core-shell structures are positioned within the plurality of spaces between the layers. The precursor material can include at least two graphene or graphene oxide layers that are attached to one another through physical forces, where a plurality of spaces are present between the layers, and a plurality of core-shell structures are positioned within the plurality of spaces between the layers. Each core-shell structure can include one of the plurality of metal sulfide containing nano or microstructures and a shell that encompasses the metal sulfide nano or microstructure, the shell comprising the carbon-containing organic polymer. The carbon containing organic polymer can be polyacrylonitrile, polydopamine, polyalkylene, polystyrene, polyacrylate, aryl polyhalide, polyester, polycarbonate, polyimide, polydopamine, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof. In some preferred instances, the carbon containing organic polymer is polyacrylonitrile. The metal sulfide can be ZnS, CuS, MnS, FeS, CoS, NiS, PbS, Ag₂S, or CdS, or any combination thereof. Once the multi-layered graphene precursor material is formed, it can then be subjected to conditions sufficient to oxidize the metal sulfide nano or microstructures to form elemental sulfur nano- or microstructures contained within hollow spaces of the carbon-containing porous shells to obtain the multi-layered graphene material of the present invention. In some aspects of the present invention, the composition used to form the precursor material can also include a metal oxide precursor. During the aforementioned heating treating step, the metal oxide precursor can be converted into a metal oxide, which can serve as a polysulfide trapping agent. In some embodiments, the metal sulfide containing nano- or microstructures includes metal oxide particles. Thus, forming a metal sulfide-metal oxide composite.

In one aspect of the present invention, 20 embodiments are described. Embodiment 1 is a multi-layered graphene material comprising: (a) at least two graphene layers that are attached to one another and have a plurality of spaces between the layers; and (b) a plurality of yolk-shell structures positioned within the plurality of spaces between the layers, each yolk-shell structure comprising: (i) an elemental sulfur nano- or microstructure; and (ii) a carbon-containing porous shell with an exterior surface and an interior surface that defines and encloses a hollow space within the interior of the shell, wherein the elemental sulfur nano- or microstructure is comprised in the hollow space, wherein the plurality of spaces between the at least two graphene layers are configured to retain the plurality of yolk-shell structures. Embodiment 2 is the multi-layered graphene material of embodiment 1, wherein the carbon-containing porous shell is electrically conductive. Embodiment 3 is the multi-layered graphene material of any one of embodiments 1 to 2, wherein the at least two graphene layers are attached to one another through a plurality of separate attachment points. Embodiment 4 is the multi-layered graphene material of embodiment 3, wherein the carbon material that forms the attachment and the carbon-containing porous shell are both derived from the same material, preferably a carbon containing polymer. Embodiment 5 is the multi-layered graphene material of any one of embodiment 1 to 4, further comprising a polysulfide trapping agent. Embodiment 6 is the multi-layered graphene material of embodiment 5, wherein the polysulfide trapping agent is embedded in the carbon-containing porous shell, in contact with the interior surface of the carbon-containing porous shell, comprised in the hollow space, and/or in contact with the elemental sulfur nano- or microstructure, or any combination thereof. Embodiment 7 is the multi-layered graphene material of any one of embodiments 5 to 6, wherein the polysulfide trapping agent is a metal oxide. Embodiment 8 is the multi-layered graphene material of embodiment 7, wherein metal oxide comprises MgO, Al₂O₃, CeO₂, La₂O₃, SnO₂, Ti₄O₇, TiO₂, MnO₂, or CaO, or any combination thereof. Embodiment 9 is the multi-layered graphene material of any one of embodiments 1 to 8, wherein the carbon-containing porous shell comprises nitrogen or a nitrogen containing compound. Embodiment 10 is the multi-layered graphene material of any one of embodiments 1 to 9, wherein the hollow space allows for volume expansion of the elemental sulfur nano- or microstructure without deforming the porous shell structure, preferably a volume expansion of at least 50%. Embodiment 11 is the multi-layered graphene material of any one of embodiments 1 to 10, wherein the multi-layered graphene material is binder-free. Embodiment 12 is the multi-layered graphene material of any one of embodiments 1 to 11, wherein the material is in the form of a sheet or film.

Embodiment 13 is an energy storage device comprising the multi-layered graphene material of any one of embodiments 1 to 12. Embodiment 14 is the energy storage device of embodiment 13, wherein the energy storage device is a rechargeable battery. Embodiment 15 is the energy storage device of embodiment 14, wherein the rechargeable battery is a lithium-ion or lithium-sulfur battery. Embodiment 16 is the energy storage device of any one of embodiments 13 to 15, wherein the multi-layered graphene material is comprised in an electrode of the energy storage device.

Embodiment 17 is a method of making the multi-layered graphene material of any one of embodiments 1 to 12, the method comprising: (a) obtaining a composition comprising a plurality of carbon-containing coated-metal sulfide nano- or microstructures, a plurality of graphene or graphene oxide layers, or composition comprising a carbon-containing organic polymer, a plurality of graphene or graphene oxide layers, and a plurality of metal sulfide nano- or microstructures; (b) forming a multi-layered graphene precursor material from the composition, the precursor material comprising; (i) at least two graphene or graphene oxide layers that are attached to one another through the carbon-containing organic polymer, wherein a plurality of spaces are present between the layers; and (ii) a plurality of core-shell structures positioned within the plurality of spaces between the layers, each core-shell structure comprising: one of the plurality of metal sulfide nano- or microstructures; and a shell that encompasses the metal sulfide nano- or microstructure, the shell comprising the carbon-containing organic polymer; (c) heat treating the multi-layered graphene precursor material to: (i) convert any graphene oxide layers to graphene; (ii) form carbon-containing porous shells from the shells comprising the carbon-containing polymer; and (iii) form at least one carbon-containing attachment point between the at least two graphene layers from the carbon-containing organic polymer; and (d) subjecting the multi-layered graphene precursor material to conditions sufficient to oxidize the metal sulfide nano- or microstructures to form elemental sulfur nano- or microstructures comprised within hollow spaces of the carbon-containing porous shells, wherein the multi-layered graphene material of any one of embodiments 1 to 12 is obtained. Embodiment 18 is the method of embodiment 17, wherein the composition of step (a) further comprises a metal oxide precursor material, and wherein the heat treating step (c) comprises calcining the composition to convert the metal oxide precursor material to a metal oxide. Embodiment 19 is the method of any one of embodiments 17 to 18, wherein the carbon containing organic polymer is polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polyacrylonitrile. Embodiment 20 is the method of any one of embodiments 17 to 19, wherein the metal sulfide is ZnS, CuS, MnS, FeS, CoS, NiS, PbS, Ag₂S, or CdS, or any combination thereof.

The following includes definitions of various terms and phrases used throughout this specification.

The phrase “multi-layered graphene” refers to 2D (sheet-like) materials, either as free-standing films or flakes, or a substrate-bound coating, consisting of a small number (between 2 and about 10) of well-defined, countable, stacked graphene layers of extended lateral dimension as described in “All in the graphene family—A recommended nomenclature for two-dimensional carbon materials”, Carbon, 2013, 65, 1-6, which is incorporated herein by reference.

The “yolk/shell like structure” phrase encompasses both core/shell and yolk/shell structures, with the difference being that in a core/shell structure at least 50% of the surface of the “core” contacts the shell. By comparison, a yolk/shell structure includes instances where less than 50% of the surface of the “yolk” contacts the shell. In either instance, a void space can be present in the yolk/shell or core/shell like structure. In preferred instances, a yolk/shell structure is used, which can have additional void space volume present in the shell when compared with a core/shell structure. This can result in a volume in the shell sufficient to allow for volume expansion of the yolk without deforming the multi-layered graphene material or the plurality of graphene layers. The yolk or core can be a nano- or microstructure.

Determination of whether a yolk/shell or a core/shell is present can be made by persons of ordinary skill in the art. One example is visual inspection of a transition electron microscope (TEM) or a scanning transmission electron microscope (STEM) image of a multi-layered graphene material of the present invention and determining whether at least 50% (core) or less (yolk) of the surface of a given nano- or microstructure (preferably a nanoparticle) contacts a graphene layer.

“Attached” as used herein refers to a physical force or a chemical bond. Physical forces include friction or static force. Chemical bond include covalent bonding, Van der Waals forces, or ionic bonding.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof “Nanoparticles” include particles having an average diameter size of 1 to 1000 nanometers, with more preferred sizes of 1 to 100 nm.

“Microstructure” refers to an object or material in which at least one dimension of the object or material is greater than 1000 nm (e.g., one dimension is greater than 1000 nm to 10000 nm). In a particular aspect, the microstructure includes at least two dimensions that are greater than 1000 nm (e.g., a first dimension is greater than 1000 nm to 10000 nm in size and a second dimension is greater than 1000 nm to 10000 nm in size). In another aspect, the microstructure includes three dimensions that are greater than 1000 nm (e.g., a first dimension is greater than 1000 nm to 10000 nm in size, a second dimension is greater than 1000 nm to 10000 nm in size, and a third dimension is greater than 1000 nm to 10000 nm in size). The shape of the microstructure can be of a wire, a particle (e.g., having a substantially spherical shape), a rod, a tetrapod, a hyper-branched structure, a tube, a cube, or mixtures thereof. “Microparticles” include particles having an average diameter size of greater than 1000 nm to 10000 nm, with more preferred sizes of 1001 nm to 5000 nm.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The multi-layered graphene materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the multi-layered graphene materials of the present invention are their ability to absorb metal ions such as lithium ions with limited to no corresponding expansion of the graphene material.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of the multi-layered graphene material of the present invention.

FIG. 2 is a schematic of the multi-layered graphene material of the present invention with polysulfide trapping agents.

FIG. 3 is a schematic of an embodiment of a method of making the graphene materials of the present invention using graphene material, a carbon-containing organic polymer and a sulfur precursor nano- or microstructure.

FIG. 4A is a schematic of an embodiment of a method of making the graphene materials of the present invention using graphene material, a carbon-containing organic polymer and a sulfur precursor nano- or microstructure containing polysulfide trapping agent precursor material.

FIG. 4B is a schematic of an embodiment of a method of making the graphene materials of the present invention using graphene material and a core/shell composite material The core/shell composite includes a carbon-containing organic polymer shell and a core that includes a sulfur precursor nano- or microstructure and polysulfide trapping agents.

FIG. 4C is a schematic of an embodiment of a method of making the graphene materials of the present invention using graphene material, a carbon-containing organic polymer, a sulfur precursor nano- or microstructure, and polysulfide trapping agents.

FIG. 5 is a schematic of another embodiment of a method of making the graphene materials of the present invention using in situ polymerization to form a polymer coating.

FIG. 6A-D show the characterization of the TiO₂—ZnS particles. FIG. 6A is the scanning electron microscopy (SEM) image. FIG. 6B is the transmission electron microscopy (TEM) image. FIG. 6C is energy dispersive X-ray (EDX) data. FIG. 6D shows X-ray diffractive (XRD) patterns of TiO₂ (bottom), ZnS (middle) and TiO₂—ZnS (top) particles.

FIG. 7A-D show characterization of the TiO₂—ZnS@polydopamine (PDA) particles. FIG. 7A is a SEM of image. FIG. 7B is a TEM image. FIG. 7C is the EDX data.

FIG. 7D shows the XRD patterns of TiO₂ (bottom), ZnS (bottom middle) and TiO₂—ZnS (top middle) particles, and TiO₂—ZnS@ (top) particles.

FIGS. 8A-F show characterization of the TiO₂—ZnS@CPDA@rGO film. FIGS. 8A and 8B show the optical images. FIG. 8C shows the SEM top view image. FIG. 8D shows SEM cross-section image. FIG. 8E shows the EDX data. FIG. 8F shows the XRD patterns of rGO film, ZnS, TiO₂ and TiO₂—ZnS@CPDA@rGO film.

FIGS. 9A-D show characterization of the TiO₂—S@CPDA@rGO film. FIG. 9A shows the SEM image. FIG. 9B shows the EDX data of the TiO₂—ZnS@CPDA@rGO film.

FIG. 9C shows the XRD patterns of rGO film, ZnS, TiO₂, TiO₂—ZnS@CPDA@rGO film and the TiO₂—S@CPDA@rGO film. FIG. 9D shows the thermogravimetric (TGA) analysis of the TiO₂—S@CPDA@rGO film.

FIGS. 10A-C show characterization of the ZnS@CPAN@Al₂O₃@rGO film. FIG. 10A shows an optical image of the ZnS@CPAN@Al₂O₃@rGO film. FIG. 10B shows the SEM image. FIG. 10C shows the EDX data.

FIGS. 11A-C show characterization of the S@CPAN@Al₂O₃@rGO film. FIG. 11A shows the SEM image of the cross-section of the S@CPAN@Al₂O₃@rGO film. FIG. 11B shows the EDX data. FIG. 11C shows the thermogravimetric (TGA) analysis.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

A solution that overcomes the problems associated with storage capacity and poor charge-discharge cycles for lithium type devices has been discovered. The solution is premised on a multi-layered graphene material that is structured to have a plurality of yolk/shell like structures positioned in a plurality spaces created between at least two graphene layers that are touching or attached to one another. Each yolk-shell structure includes an elemental sulfur nano- or microstructure(s) and a carbon-containing porous shell with an exterior surface and an interior surface that defines and encloses a hollow space within the interior of the shell that includes the elemental sulfur yolk. In some embodiments, the yolk includes a polysulfide trapping agent/elemental sulfur composite. In certain non-limiting aspects, the elemental sulfur nano- or microstructures can attract and hold lithium ions. Without wishing to be bound by theory, it is believed that when the multi-layered graphene material is lithiated or charged, the nano- or microstructure expands (due to the addition of the lithium ion to the elemental sulfur) inside the graphene layers and causes minimal to no deformation or expansion of the graphene layers. Notably, this architecture enables three dimensional expansion of the elemental sulfur nano- or microstructure in the hollow space created between porous carbon-containing shell and the nano- or microstructure without damaging the graphene layers. Embodiments of the present invention also include polysulfide trapping agents incorporated in the multi-layer graphene material.

These and other non-limiting aspects of the present invention are discussed in further detail in the following sections with reference to the Figures.

### A. Multi-Layered Graphene Materials

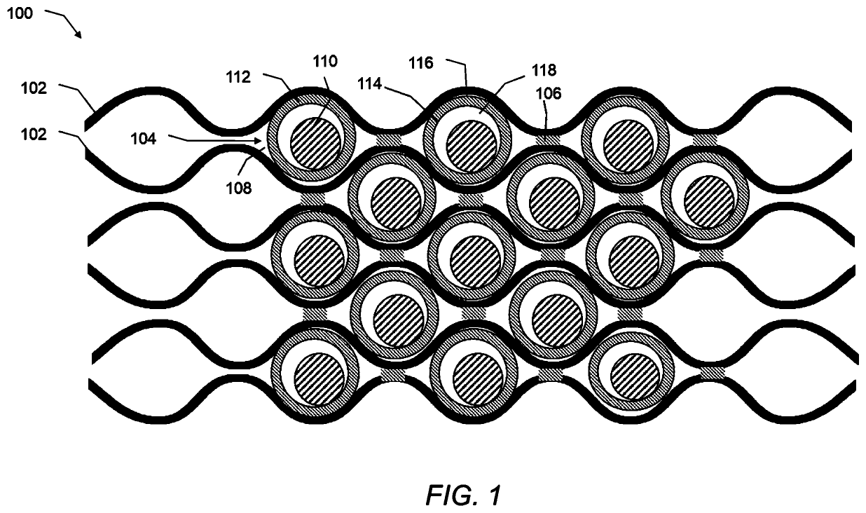

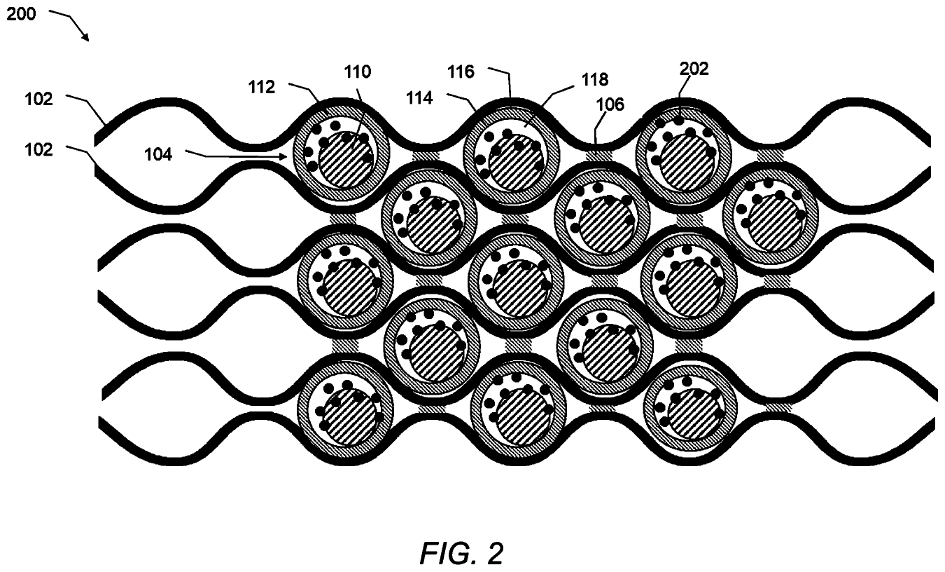

FIGS. 1 and 2 are schematics of multi-layered graphene materials of the present invention that include elemental sulfur yolk-carbon shell nano- or microstructures. FIG. 1 depicts a multi-layered graphene material having a sulfur yolk/carbon shell nano- or microstructure positioned in a void space created between two attached graphene layers. FIG. 2 depicts a multi-layered graphene material having a sulfur yolk/carbon shell nano- or microstructure positioned in a void space created between two attached graphene layers, and polysulfide trapping agents. Referring to FIGS. 1 and 2, multi-layer graphene materials 100 and 200 include graphene layers 102 and yolk-shell nano- or microstructures 104. At least two graphene layers 102 can be attached to each other by carbon material 106. Attachment (e.g., welding or physical forces) of graphene layers 102 can create defined void spaces 108 between graphene layers 102, aid in retaining nano- or microstructures 104 between two graphene layers, and/or eliminate the need for binders and/or conductive additives. Attachment of the graphene layers can assist in inhibiting the shuttle effect of higher order Li₂Sₙ where 4≤n≤8. Nano- or microstructures 104 can include elemental sulfur yolk 110 and carbon-containing porous shell 112, having inner surface 114, outer surface 116, and hollow space 118. In some embodiments, carbon material 106 and carbon-containing porous shell 112 are made from the same material (e.g., carbonized polyacrylonitrile). Use of a polyacrylonitrile polymer can produce a nitrogen enriched carbon-containing porous shell, which can lead to increased adsorption of polysulfides. Outer surface 116 can touch at least one surface of graphene layer 102. Elemental sulfur yolk 110 can be positioned in hollow space 118 and contact inner surface 114 of shell 112. Thus, elemental sulfur yolk 110 is encompassed by a carbon-containing double shell. In some embodiments elemental sulfur yolk 110 is a polysulfide trapping agent/elemental sulfur composite material.

As shown in FIG. 1, each hollow space 118 of the graphene material 100 includes 1 nano- or microstructure yolk 110, however, it should be understood that each hollow space can include 2, 3, 4, 5, or more nano- or microstructure yolks (“multi-yolk”). The average volume of each hollow space can be 5 nm³ to 1,000,000 nm³ (10⁶ μm³) or 10 nm³ to 10⁵ μm³, 100 nm³ to 10⁴ μm³, or any range there between. In some embodiments, the yolk nano- or microstructures 110 can fill less than 50%, 40%, 30%, or 20% of the volume of each hollow space. Hollow spaces 118 can have a volume sufficient to allow for volume expansion of the nano- or microstructure without deforming the graphene layers (shell) 102. In some instances, hollow space 118 can have a volume sufficient to allow for at least 50% volume expansion, at least 80% volume expansion, preferably 200% to 600% volume expansion of the at least one of the yolk nano- or microstructures without deforming the graphene layers 102. In some instances the graphene material has a flow flux of 1×10⁻⁹ to 1×10⁻⁴ mol m⁻² s⁻¹ Pa.

Referring to FIG. 2, the multi-layered graphene material 200 of the present invention can include polysulfide trapping agents 202. Polysulfide trapping agents 202 can be embedded in carbon-containing porous shell 112, in contact with interior surface 114 of the carbon-containing porous shell, included in hollow space 118, and/or in contact with elemental sulfur nano- or microstructure 110, or any combination thereof. In some embodiments, polysulfide trapping agent 202 and the metal sulfide precursor is a composite material. The polysulfide trapping agents can be a metal oxide of elements from Columns 1 to 15 of the Periodic Table. Non-limiting examples of metal oxides include magnesium oxide (MgO), calcium oxide (CaO), strontium oxide (SrO), barium oxide (BaO), cesium oxide (CsO), silica (SiO₂), alumina (Al₂O₃), titania (TiO₂), substoichiometric titanium oxide (e.g. Ti₄O₇ in the in the Magnéli phase), zirconia (ZrO₂), manganese oxide (MnO), zinc oxide (ZnO), iron oxide (Fe₂O₃), gallium oxide (Ga₂O₃), germania (GeO₂), stannic oxide (SnO₂), hafnia (HfO₂), yttria (Y₂O₃), lanthana (La₂O₃), ceria (CeO₂), or any combinations or mixed metals oxide thereof. Elemental sulfur nano- or microstructures 110, polysulfide trapping agent nanostructures 202 or composites thereof, can have a variety of shapes or sizes. By way of example, nano- or microstructures 110 or 202 can have the shape of a wire, a particle (e.g., having a substantially spherical shape), a rod, a tetrapod, a hyper-branched structure, a tube, a cube, or mixtures thereof. In particular instances, the nano- or microstructures 110 and/or 202 are nanoparticles that are substantially spherical in shape. The diameter of the elemental yolk nano- or microstructures 110 can be 1 nm to 10,000 nm, 5 nm to 1000 nm, 10 nm to 100 nm, 1 nm to 50 nm, or 1 nm to 5 nm, or 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 nm, or any range or value there between. In some preferred instances, the diameter of the elemental yolk nano- or microstructures 110 is 10 nm to 10,000 nm (10 μm).

B. Preparation of Multi-Layered Graphene Materials with Yolk@Shell Structures

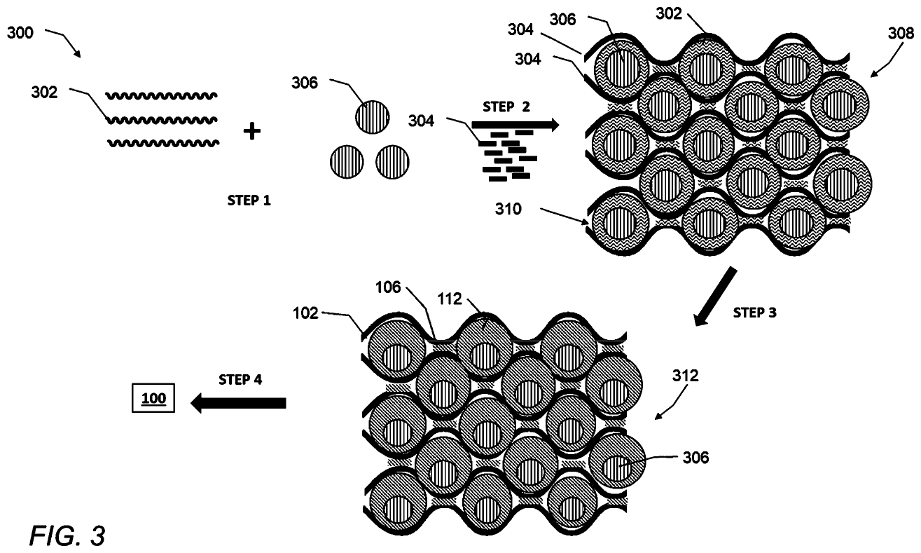

FIGS. 3, 4A, 4B, 4C and 5 are schematics of methods 300, 400, 410, 420 and 500 for preparing multi-layered graphene materials having yolk-shell type structures. The methods can include one or more steps that can be used in combination to make a multi-structured graphene material. Step 1 of methods 300, 400, 410, 420, and 500 can include obtaining a plurality of graphene material and/or a carbon containing organic polymer, a polymer precursor material, and a plurality of sulfur precursor containing nano- or microstructures, a plurality of polysulfide trapping agents, or composites thereof, or combinations thereof. Obtaining can include making one or more solutions of the one or more ingredients. In some embodiments, the graphene material is obtained separately and then added to one or more solutions of the other components, mixtures of components, or composites thereof prior to or during step 2. The graphene layers used as starting materials can be obtained from a commercial source or made according to conventional processes. In a preferred embodiment, the graphene layers are graphene oxide layers. In some embodiments of step 1, the sulfur precursor nano- or microstructures 306, polysulfide trapping agent nanostructures 202 and/or polysulfide trapping agent precursors 404 are particles.

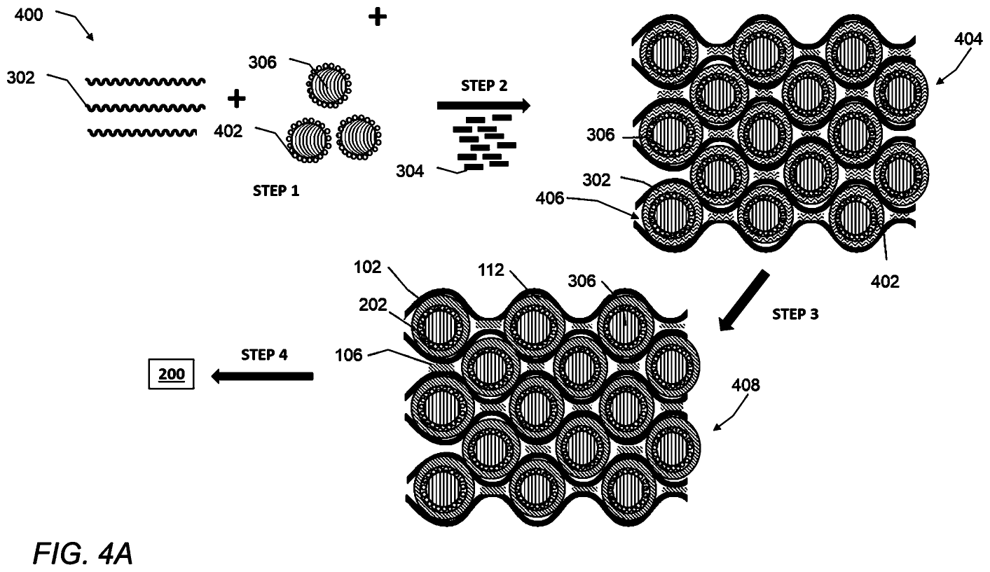

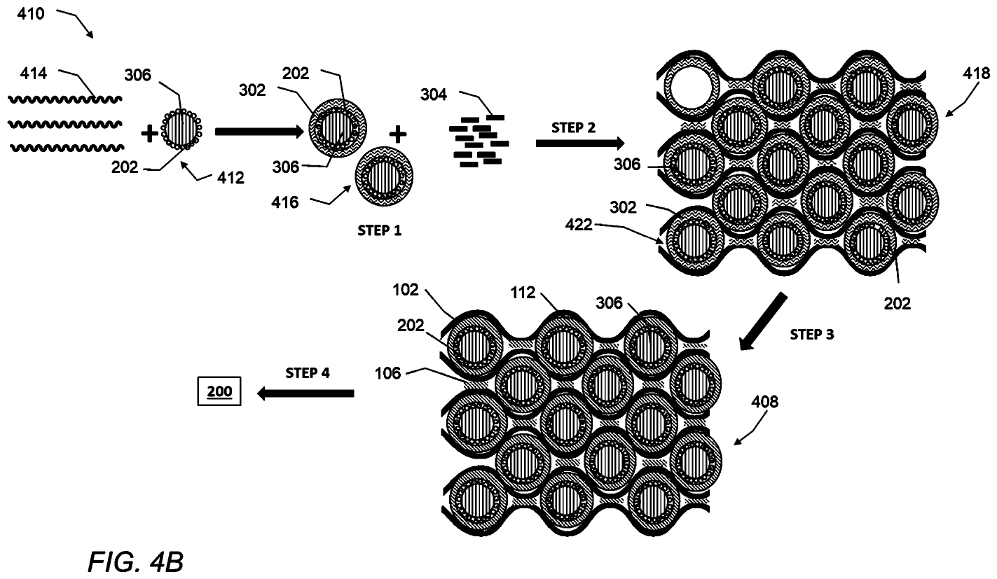

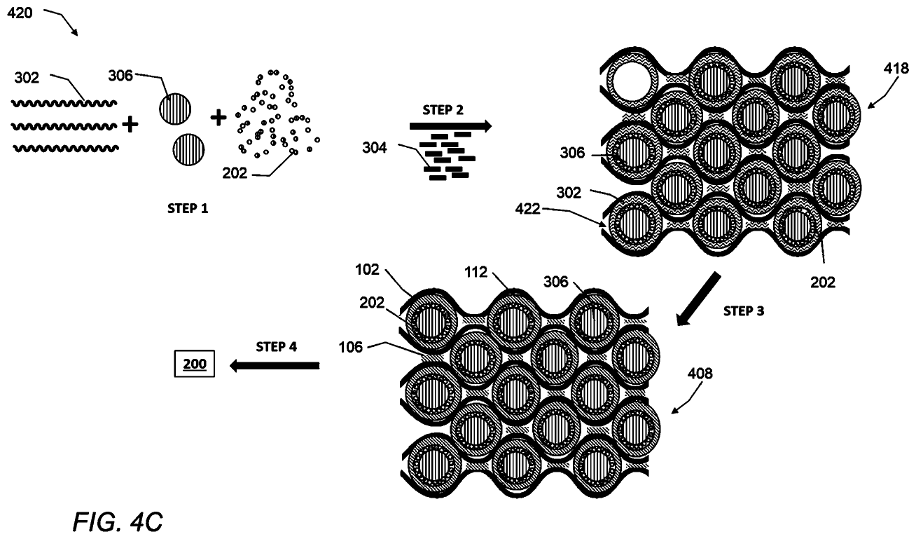

In method 300, carbon containing organic polymer material 302, graphene material 304 and sulfur precursor nano- or microstructure 306 can be obtained. In some instances, carbon containing organic polymer material 302 and sulfur precursor nano- or microstructure 306 are obtained as a separate solution from the graphene material 304 and combined together to form one solution prior to or during step 2. In method 400, sulfur precursor nano- or microstructure 306 includes polysulfide trapping agent precursor 402. In some embodiments, step 1 can include obtaining a plurality of graphene material 304, a plurality of sulfur precursor nano- or microstructures 306 having a carbon-containing organic polymer coating and/or the sulfur precursor nano- or microstructures 306 and polysulfide trapping agent nanostructures 404 having a carbon-containing organic polymer coating. As shown in FIG. 4A, the polysulfide trapping agents are dispersed on the surface of the sulfur precursor nano- or microstructures.

As shown in FIG. 4B, graphene material and microstructure 416 can be obtained. Microstructure 416 can be a core/shell structure that includes nano- or microstructures 306, polysulfide trapping agent 202, and carbon containing organic polymer 302. Microstructure 416 can be obtained by reacting a nano- or microstructure/polysulfide composite 412 with a carbon-containing organic polymer precursor 414. As shown, polysulfide trapping agents are on the outside of the nano- or microstructure 306. It should be understood that the polysulfide trapping agents can be dispersed throughout the nano- or microstructure 306. By way of example, composite 412 can be dispersed in a water solution, carbon-containing organic polymer precursor 414 (e.g., a monomer) can be added to the aqueous solution and the solution agitated until the polymer precursor polymerizes in situ around the composite material to form core/shell structure 416. Polymer precursor 414 can be any monomer that can form a polymer coating. Non-limiting examples include an aromatic amines, dopamine, or the like. Polymerization temperatures can range from 20 to 45° C., or 25 to 35° C., or any value there between, or about 25° C. (e.g., room temperature). The amount of time for the polymerization reaction can be 30 minutes to 5 days, 1 hour to 4 days or 2 to 3 days or any value there between.

As shown in FIG. 4C, step 1 of method 420, the graphene material, carbon-containing organic polymer 302, nano- or microstructure 306, and polysulfide trapping agents 202 can be obtained. By way of example, a solution of polymer, nano- or microstructures and polysulfide trapping agents can be obtained.

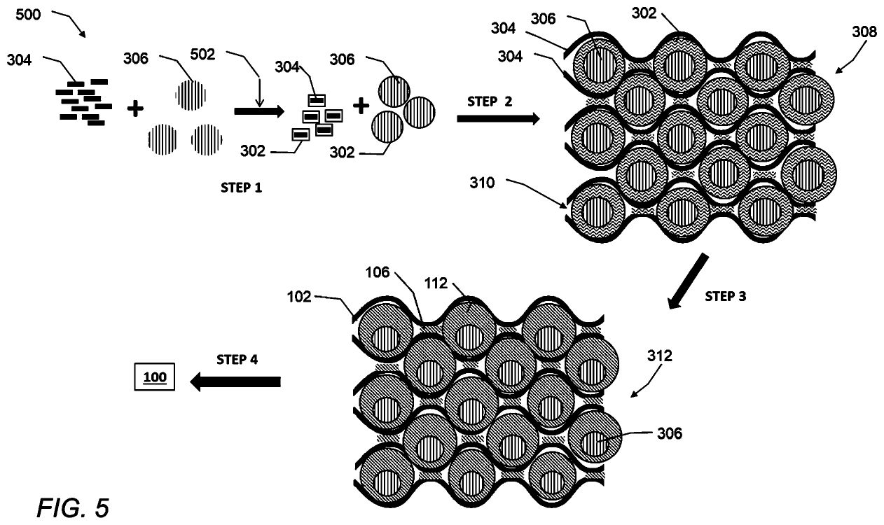

As shown in FIG. 5, step 1 of method 500, can include obtaining a plurality of graphene material 304, a plurality of sulfur precursor nano- or microstructures 306, and a carbon-containing monomer 502. The graphene material 304 and sulfur precursor nano- or microstructures can be coated with the carbon-containing monomer and subjected to conditions to polymerize the monomer and form polymer coating 302 on the graphene structures 304 and sulfur precursor nano- or microstructures 306 or a composite of sulfur precursor/polysulfide trapping agent (not shown). Carbon containing organic polymer precursor 502 can be any monomer that can form a polymer coating. Non-limiting examples include an aromatic amines, dopamine, or the like.

In step 2 of methods 300, 400, 410, 420 and 500 multi-layered graphene precursor materials 308 (FIGS. 3 and 5) and 404 (FIGS. 4A-4C), respectively, can be formed. Multi-layered graphene precursor material 308 can include carbon-containing organic polymer 302, graphene layers 304, and sulfur precursor nano- or microstructures 306. Multi-layered graphene precursor material 404 includes carbon-containing organic polymer 302, graphene layers 304, sulfur precursor nano- or microstructures 306 and polysulfide trapping agent precursor nanostructures 402 and/or polysulfide trapping agent nanostructures (414 in FIGS. 4B and 4C).

The ingredients of step 1 (e.g., a solution of nano- or microstructures 306 and carbon-containing organic polymer 302, a solution of nano- or microstructures 306 with polysulfide precursor 402 and carbon-containing organic polymer 302, a solution of nano- or microstructures 416, a solution of carbon-containing organic polymer 302, nano- or microstructure 306 and polysulfide trapping agents 202, and/or a solution of polymer coated graphene) can be combined with graphene prior together or sequentially, and then vacuum filtered or cast to intercalate the plurality of polymer coated nano- or microstructures (e.g., nano- or microstructures 306, 402, 416, 202, etc.) between polymer coated single graphene oxide layers 304 to form intercalated graphene material 308, 404, and/or 418. Polymer coated nano- or microstructures (e.g., nano- or micro-structures 416) can be suspended in an aqueous and/or nonaqueous medium be vacuum filtered or cast to intercalate the plurality of polymer coated nano- or microstructures between the polymer coated single graphene oxide layers. In some embodiments, graphene material 304, a plurality of sulfur precursor nano- or microstructures 306, polysulfide trapping agent 202 and/or the sulfur precursor nano- or microstructures 306 and polysulfide trapping agent nanostructures 402 having a carbon-containing organic polymer coating are suspended in an aqueous and/or nonaqueous medium and then vacuum filtered or cast to intercalate the polymer coated nano- or microstructures (e.g., nano- or microstructures 306, 306 with 402, 416, 202, etc.) between polymer coated single graphene oxide layers 304 to form intercalated graphene material 308, 404, or 418. The intercalation process is a “self-assembly” process that occurs during vacuum filtration or casting. The formed intercalated graphene materials 308, 404, or 418 include a plurality of graphene layers 304 with composites 310, 406, and 422 (e.g., cores) dispersed between the graphene layers. Composites 310, 406, and 422 can include nano- or microstructures 306 (FIG. 3), nano- or microstructures 306 with polysulfide precursor agents 402 (FIG. 4A), or nano- or microstructures 306 and polysulfide trapping agents 202 (FIGS. 4B and 4C) coated with the carbon-containing organic polymer 302, which can form a shell-precursor material around the nano- or microstructures, respectively. Two graphene oxide layers 304 form a shell-like material around the composites 310, 406, and 422, thereby forming a core-double shell type structure, with the graphene being one of the shells. The composites 310, 406, and/or 422 can be in full, or substantially full, contact with graphene oxide layers 304. In some embodiments, 50% to 100%, 50% to 99%, 60% to 95%, or 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or any range or value there between, of the surface of the composites 310, 406, and 422 contacts the graphene layers 304.

In step 3, the intercalated graphene material(s) 308, 404 and/or 418, can be heat treated to: (i) convert any graphene oxide layers 304 to graphene layers 102; (ii) form carbon-containing porous shells 112 from the shells that included the carbon-containing polymer 302; (iii) form at least one carbon-containing attachment point 106 between the at least two graphene layers from the carbon-containing organic polymer; and, optionally, (iv) convert polysulfide trapping agent precursor material 402 to the polysulfide trapping agent 202, or any combination thereof. Such heat treatment forms materials 312 and 408, respectively. Heat-treating temperatures can range from 500° C. to 1000° C., 700° C. to 900° C., or 500° C., 525° C., 550° C., 575° C., 600° C., 625° C., 650° C., 675° C., 700° C., 725° C., 750° C., 775° C., 800° C., 825° C., 850° C., 875° C., 900° C. or any range or value there between. After heat treating, the formed graphene materials 312 and 408 having sulfur precursor nano- or microstructures 306 or sulfur precursor nano- or microstructures 306 in combination with polysulfide trapping agent 202 can be subjected to conditions to convert the sulfur precursor to sulfur, cool to ambient temperatures, or both. In some embodiments, the formed graphene materials 312 and/or 408 are films.

In step 4, the multi-layered graphene material(s) 312 and/or 408 can be subjected to conditions sufficient to oxidize the sulfur in the sulfur precursor nano- o microstructures 306 to form elemental sulfur nano- or microstructures 110 and hollow spaces 118. Formation of hollow spaces creates yolk-shell structure 104 having sulfur yolks 110 positioned in carbon shell 112 with optional polysulfide trapping agents 202. In a non-limiting example, the multi-layered graphene material(s) 312 and/or 408 can be immersed in an aqueous ferric nitrate solution until the sulfur precursor (e.g., metal sulfide) is converted to elemental sulfur (e.g., 12 to 20 hours) as shown in the reaction equation below using zinc sulfide as an exemplary elemental sulfur precursor material.

2Fe³⁺_{(aq)}+ZnS₍ₛ₎→2Fe²⁺_{(aq)}+Zn²⁺_{(aq)}+S₍ₛ₎

### C. Materials 1. Metal Sulfide Nano- or Microstructures, Polysulfide Trapping Agent Precursors, and Polysulfide Trapping Agents

Metal sulfide nano- or microstructures, polysulfide trapping agents, and polysulfide trapping agents can be obtained from commercial sources (e.g., Sigma-Aldrich®, U.S.A. or American Elements, U.S.A) or made. In some embodiments, the metal sulfide nano- or microstructures or metal sulfide/metal-oxide composite can be obtained through autogenous thermal methodology know in the art. (See, for example, Ding et al., Journal of Materials Chemistry A, 2015, 3, 1853-1857). In a non-limiting example, a metal precursor material (e.g., a metal acetate, metal sulfate, metal nitrate, metal chloride, or the like) can be mixed with a sulfur source (e.g., a mercaptan, thiourea, or the like) and optional polysulfide trapping agent (e.g., metal oxide particles) and a templating agent (e.g., gum arabic) to form a mixture. In some embodiments, the mixture is homogeneous. A molar ratio of metal precursor material and sulfur source can range from 0.1:10 to 10:0.1, or any range or value there between, or about 0.5. In some embodiments, the reagents can be sonicated or ultrasonicated under agitation. The resulting homogeneous mixture can be heated at a suitable pressure to react the metal precursor material with the sulfur source. Reaction temperatures can range from 50° C. to 1000° C., 100 to 500° C., 110 to 150° C. or any range or value there between at thermally controlled pressure (e.g., autogenous pressure). The crude metal sulfide or metal sulfide-polysulfide trapping agent composite can be collected (e.g., centrifuged, filtered or the like), washed with deionized water to remove unreacted reagents, and dried at temperatures and pressures suitable to remove the residual water.

The sulfur precursor that is converted to sulfur can include transition metals and post transition metals. Non-limiting examples of transition metals and post transition metals include Iron (Fe), ruthenium (Ru), rhenium (Re), palladium (Pd), cobalt (Co), rhodium (Rh), nickel (Ni), platinum (Pt), copper (Cu), silver (Ag), gold (Au), zinc (Zn), cadmium (Cd), mercury (Hg), thallium (Tl), tin (Sn), lead (Pb), or any combination thereof. In some embodiments, the sulfur precursor can be a sulfide of any transition metal or post transition metal, preferably, ZnS, CuS, MnS, FeS, CoS, NiS, PbS, Ag₂S, or CdS, or any combination thereof. In a preferred embodiment, the metal sulfide is zinc sulfide.

The polysulfide trapping agent precursor material can be a metal hydroxide material that upon calcination (e.g., heating at elevated temperatures in the presence of an oxygen source) can be converted to a metal oxide. Metal hydroxide can be prepared using methods known in the art, such as precipitation method, sol-gel methods and the like. (See, for example Goudarzi et al., Journal of Cluster Science 2015, 27, 25-38). In a non-limiting embodiment, the metal hydroxide can be prepared using a precipitation method. In the precipitation method, a metal precursor (e.g., a nitrate, acetate, sulfate, chloride) can be dissolved in water (e.g., distilled water) and a precipitating agent can be added to adjust the pH of the solution to a value that induces precipitation of the metal hydroxide from the water. The pH can be adjusted to a value of 5 to 10, 6 to 9, 7 to 8, or about 8. Precipitating agents can include amines, diamines, (e.g., ethylenediamine tetraacetic acid) and the like. The metal hydroxide can be separated from the water using known methods such as filtration, centrifugation, and the like. The metal hydroxide (polysulfide trapping agent precursor) can be washed to remove any residual unreacted agents and dried to remove any residual water. In some embodiments, the metal hydroxide can be converted to a metal oxide prior to mixing with the graphene layers and carbon-containing organic polymer. In such embodiments, the metal hydroxide can be heated in oxygen rich air at a temperature suitable to convert the metal hydroxide to a metal oxide. Calcining temperatures can range from 350° C. to 1200° C., 400° C. to 1000° C., 500° C. to 900° C. or any range or value there between. In some embodiments, metal oxides particles are added to the metal sulfide precursor solution as described above to form a metal oxide/metal sulfide composite. In a preferred embodiment, the nano- or microstructure is a TiO₂—ZnS composite.

The amount of nano- or micro-structures (e.g., sulfur precursor nano- or microparticles, polysulfide trapping agent nanoparticles, polysulfide trapping agent precursor nanoparticles, sulfur precursor nano- or micro-particles/polysulfide trapping agent nanoparticles composite, or a combination thereof) in the multi-layer graphene material depends, inter alia, on the use of the multi-layer graphene material. In a particular instance, the multi-layer graphene material can include 0.1 wt. %, 1 wt. %, 10 wt. % to 90 wt. %, 20 wt. % to 80 wt. %, 30 wt. % to 70 wt. %, 40 wt. % to 60 wt. %, or any range or value there between of the nanostructures.

The methods used to prepare the multi-layered graphene materials 100 and 200 of the present invention can be modified or varied as desired to design or tune the size of the space between the graphene layers, the selection of sulfur precursors, the dispersion of the polysulfide trapping nanostructures in the graphene layers, in the hollow spaces of the yolk-shell structure, or attached to or dispersed in the sulfur nano- or microparticles, the porosity and pore size of the graphene material, etc., to design an article of manufacture, an energy storage device, or other devices.

2. Carbon-Containing Organic Polymer

The carbon-containing organic polymer 302 can be any polymer suitable for forming a porous carbon shell. The carbon-containing organic polymer is also capable, through chemical-chemical bonds, to attach (weld) at least two graphene layers to one another. Polymers are available from commercial vendors or made according to conventional chemical reactions. In some embodiments, the polymer is a thermoset polymer, a thermoplastic polymer, a natural-sourced polymer, or a blend thereof. The polymer can also include additives that can be added to the composition. Non-limiting examples, of natural-sourced polymers include starch, glycogen, cellulose, or chitin.

Thermoset polymeric matrices are cured or become cross-linked and tend to lose the ability to become pliable or moldable at raised temperatures. Non-limiting examples of thermoset polymers used to make nanostructure shell and attach the graphene layers together include epoxy resins, epoxy vinylesters, alkyds, amino-based polymers (e.g., polyurethanes, urea-formaldehyde), diallyl phthalate, phenolic polymers, polyesters, unsaturated polyester resins, dicyclopentadiene, polyimides, silicon polymers, cyanate esters of polycyanurates, thermosetting polyacrylic resins, phenol formaldehyde resin (bakelite), fiber reinforced phenolic resins (Duroplast), benzoxazines, or co-polymers thereof, or blends thereof. In addition to these, other thermoset polymers known to those of skill in the art, and those hereinafter developed, can also be used in the context of the present invention. The thermoset polymer can be included in a composition that includes said polymer and additives. Non-limiting examples of additives include coupling agents, antioxidants, heat stabilizers, flow modifiers, etc., or any combinations thereof. In some embodiments, one or more monomers capable of being polymerized when exposed to heat, light or electromagnetic force are used. Such monomers can be precursor materials suitable for forming thermoset polymers. The polymers and/or monomers are available from commercial vendors or made according to conventional chemical reactions.

Thermoplastic polymeric matrices have the ability to become pliable or moldable above a specific temperature and solidify below the temperature. The polymeric matrix of the material can include thermoplastic or thermoset polymers, co-polymers thereof, and blends thereof that are discussed throughout the present application. Non-limiting examples of thermoplastic polymers include polyacrylates, polyacrylonitrile (PAN), polyethylene terephthalate (PET), a polycarbonate (PC) family of polymers, polybutylene terephthalate (PBT), poly(1,4-cyclohexylidene cyclohexane-1,4-dicarboxylate) (PCCD), glycol modified polycyclohexyl terephthalate (PCTG), poly(phenylene oxide) (PPO), polyalkylene, polyalkylene glycol, polypropylene (PP), polyethylene (PE), polyethylene glycol, polyvinyl chloride (PVC), polystyrene (PS), polymethylmethacrylate (PMMA), thermoplastic polyimides, polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polystyrene sulfonate (PSS), sulfonates of polysulfones, polyether ether ketone (PEEK), polyether ketone ketone (PEKK), acrylonitrile butyldiene styrene (ABS), polyphenylene sulfide (PPS), aryl polyhalides, polyesters, polysaccharide, co-polymers thereof, or blends thereof. In particular instances, polyacrylonitrile (PAN) can be a preferred polymer for making the carbon shells and attachment points. In addition to these, other thermoplastic polymers known to those of skill in the art, and those hereinafter developed, can also be used in the context of the present invention.

In some particularly preferred embodiments, the carbon-containing organic polymer can be polyacrylonitrile, polydopamine, polyalkylene, polystyrene, polyacrylate, aryl polyhalide, polyester, polycarbonate, polyimide, phenol formaldehyde resin, epoxy resins, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polyacrylonitrile.

D. Articles of Manufacture and Applications of the Multi-Layered Graphene Material

The multi-layered graphene materials 100 and 200 can be included in articles of manufacture, made into sheets, films, or incorporated into membranes. The sheet or film can have a thickness of 10 nm to 500 μm. The article of manufacture can include an electronic device, a gas or liquid separation membrane, a catalytic membrane for catalyzing a chemical reaction, a catalyst material, a controlled release medium, a sensor, a structural component, an energy storage device, a gas capture or storage material, or a fuel cell. In a particular instance, the multi-layer graphene materials of the present invention are used in an energy storage device. The term “energy storage device” can refer to any device that is capable of at least temporarily storing energy provided to the device and subsequently delivering the energy to a load. Non-limiting examples of energy storage devices include rechargeable batteries (e.g., lithium-ion or lithium-sulfur batteries fuel cells, batteries, supercapacitors, electrochemical capacitors, and/or any other battery cell system or pack technology). In some embodiments, an energy storage device may include one or more devices connected in parallel or series in various configurations to obtain a desired storage capacity, output voltage, and/or output current. Such a combination of one or more devices may include one or more forms of stored energy. By way of example a lithium ion battery can include the previously described porous carbon-containing material or multi-yolk/porous carbon-containing material (e.g., on an anode electrode and/or a cathode electrode). In another example, the energy storage device can also, or alternatively, include other technologies for storing energy, such as devices that store energy through performing chemical reactions (e.g., fuel cells), trapping electrical charge, storing electric fields (e.g., capacitors, variable capacitors, ultracapacitors, and the like), and/or storing kinetic energy (e.g., rotational energy in flywheels). In some embodiments, the article of manufacture is a virtual reality device, an augmented reality device, a fixture that requires flexibility such as an adjustable mounted wireless headset and ear buds, a communication helmet with curvatures, a medical patch, a flexible identification card, a flexible sporting good, a packaging material and applications where the energy source can simply final product design, engineering and mass production.

In some instances, the flexible composites of the present invention can enhance energy density and flexibility of flexible supercapacitors (FSC). The resultant flexible composites can include an open two-dimensional surface of graphene that can contact an electrolyte in the FSC. Moreover, the conjugated π electron (high-density carrier) of graphene can minimize the diffusion distances to the interior surfaces and meet fast charge-discharge of supercapacitors. Further, micropores of the composites of the present invention can strengthen the electric-double-layer capacitance, and mesopores can provide convenient pathways for ions transport.

In some instances, the multi-layered graphene material with electroactive nano- or microstructures can be included in a lithium battery. When the battery is charged, the lithium ions are attracted to the electroactive nanostructures (e.g., sulfur) intercalated in the reduced graphene layers 102. The lithium ions can be electrostatically attached to the electroactive nanostructures and form lithiated electroactive nanostructures. Due to the lithiation, the volume of the lithiated electroactive nanostructures is increased as compared to the unlithiated nanostructures. Since the nanostructures are positioned in a 3-dimensional void space, they have sufficient space to expand, while the total volume of the multi-layered graphene material remains substantially unchanged. For example, total volume of the multi-layered graphene material, when lithiated or charged, can be within 10%, 5%, 4%, 3%, 2%, 1%, or less of the volume of the multi-layered graphene material, when unlithiated or uncharged.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Materials and Instrumentation

Zinc acetate dihydrate, thiourea, titanium oxide, ferric nitrate nonahydrate, dopamine hydrochloride, tris(hydroxymethyl)aminomethane, polyacrylonitrile (Mw=150,000), nitric acid, Arabic gum, zinc sulfide, ethanol and N,N-Dimethylformamide (DMF) were purchased from Sigma-Aldrich® (U.S.A.). Fumed Al₂O₃ was purchased from Evonik Industries AG (Germany). Graphene oxide (GO) was purchased from Nanjing JCNano (China).

Scanning electron microscopic (SEM) images were taken by a Nova NanoSEM (FEI a ThermoFisher Scientific company, U.S.A.). Transmission electron microscope (TEM) pictures were obtained by a Tecnai Twin TEM (FEI) operating at 120 kV. Optical images were taken using a cellphone camera (Huawei Mate 10, Huawei Technologies Co., LTD, China). Energy dispersive x-ray spectroscopy (EDX) was obtained using a Nova NanoSEM (FEI) operated at 15 kV. X-ray diffraction (XRD) patterns were recorded at room temperature on a powder PANalytical Empyrean (PANalytical B. V, the Netherland), diffractometer using CuKα radiation (λ=1.54059 Å) at 40 kV and 40 mA. Thermogravimetric analysis (TGA) was obtained using a TGA Q500 (TA Instruments, U.S.A.) from 25 to 800° C. with a heat ramp of 10° C./min under nitrogen atmosphere.

### Example 1

### (Preparation and Characterization of Elemental Sulfur Precursor Material (TiO₂—ZnS) Composite Nanoparticles)

Preparation.

The procedure of Ding et al., (Journal of Materials Chemistry A, 2015, 3:1853-1857) was followed to prepare zinc sulfide (ZnS) nanoparticles. International Application No. PCT/US2018/012358 to Liu et al., which is incorporated herein by reference was followed to prepare the carbon-containing coated composite nanoparticles. Zinc acetate dihydrate (8.78 g, 0.04 mol, Sigma-Aldrich®, U.S.A.), titanium dioxide nanoparticles (TiO₂, 0.04 mol, 3.2 g, particle size of 21 nm, Sigma-Aldrich®, U.S.A.) and thiourea (6.08 g, 0.08 mol, Sigma-Aldrich®, U.S.A.) were dissolved in deionized water (400 mL) and added into a polyfluoroethylene bottle. Gum arabic (6 g, Sigma-Aldrich®, U.S.A.) was added as a surfactant for the formation of the spheres. The solution was stirred and sonicated to ensure complete dissolution of the reagents and then the bottle was positioned in a polyfluoroethylene lined autoclave. The autoclave was sealed and placed into an oven at about 120° C. for 15 hours. The resulting white zinc sulfide precipitate was isolated via centrifugation, washed several times with deionized water, and then dried in an oven at about 70° C. for 3 hours.

Characterization.

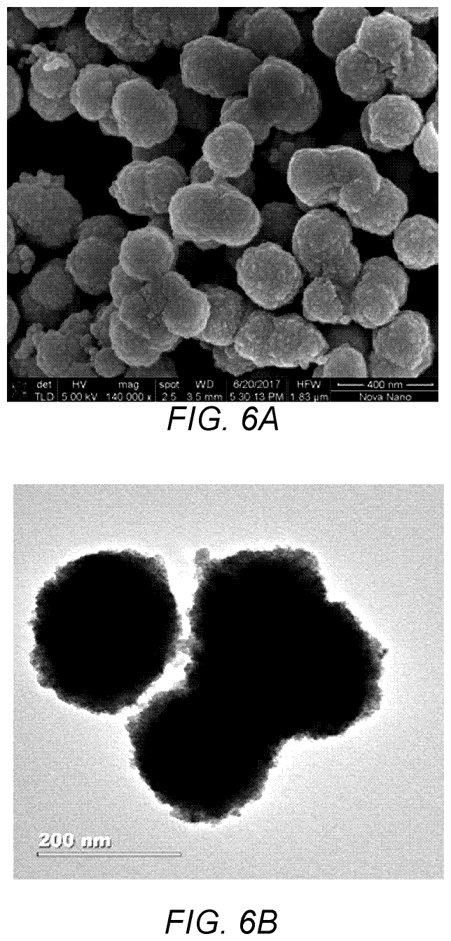

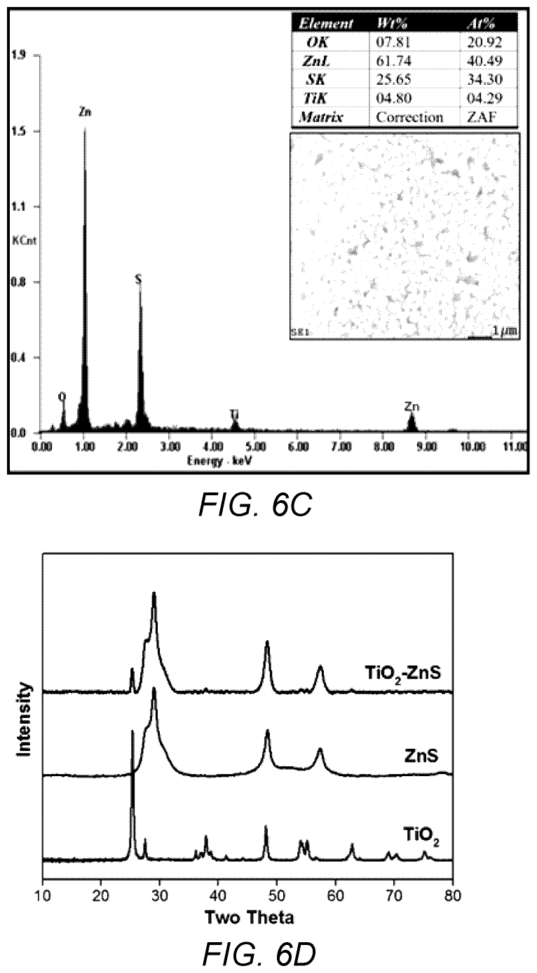

FIGS. 6A and 6B show the SEM and TEM images of TiO₂—ZnS composite nanoparticles. Using these images, the size was determined to be around 220 nm. EDX analysis (FIG. 6C) shows the composite particles contained Zn, S, Ti and O atoms, which indicated the desired composite was obtained. The composite particles included 7.81 wt. % 0, 61.74 wt. % Zn, 25.65 wt. % S, and 4.8 wt. % Ti. The XRD patterns (FIG. 6D) also provided proof that the synthesized particles contained ZnS and TiO₂. As shown in FIG. 6D, the XRD of TiO₂—ZnS contained all the peaks of ZnS and TiO₂.

### Example 2

### Preparation and Characterization of TiO₂—ZnS@PDA Core-Shell Nanoparticles

Preparation.

TiO₂—ZnS (2 g) and tris(hydroxymethyl)aminomethane (1.44 g, 12 mmol) of Example 1 were dispersed in H₂O (400 mL) by Soinc Dismembrator (Fisher Scientific (USA), Model 550, 40%, 1 h) and then dopamine hydrochloride (0.8 g, 4 mmol) was added to the dispersion, and the dispersion was stirred for 3 days at room temperature. The product TiO₂—ZnS@PDA was collected via centrifugation, washed with deionized (DI) water 3 times and ethanol twice, and then dried under vacuum at 70° C. overnight.

Characterization.

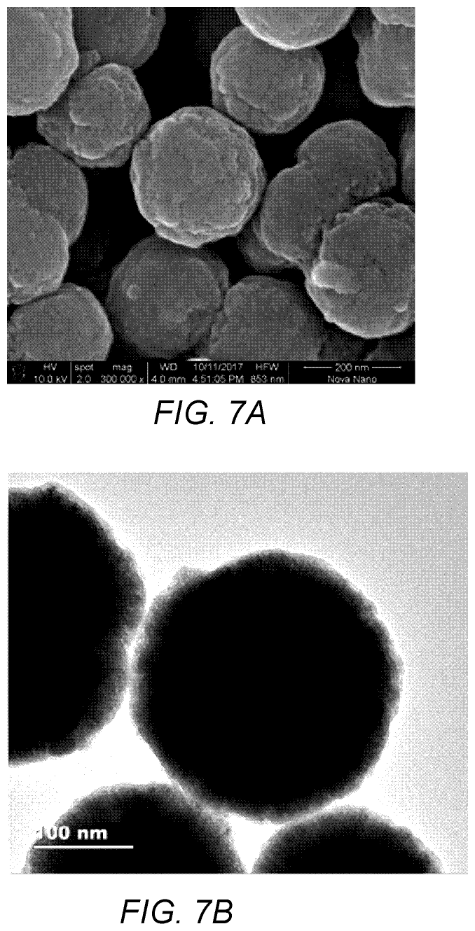

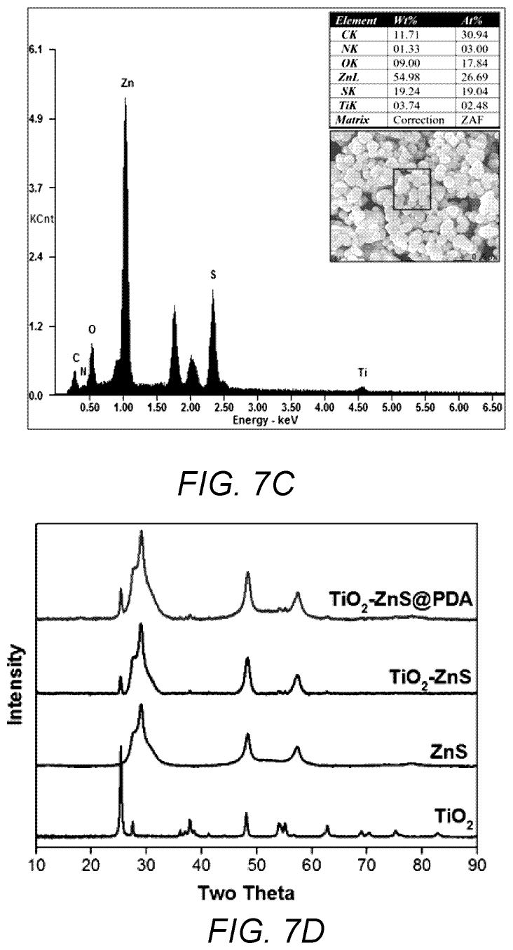

FIGS. 7A and 7B show the SEM and TEM images of TiO₂—ZnS@PDA core-shell particles. The TEM image shows a very thin layer on the surface of TiO₂—ZnS particles. From, the EDX analysis (FIG. 7C) it was determined that the core-shell particles contained C, Zn, S, Ti, N and O atoms. The core-shell particles included 11.71 wt. % C, 1.33 wt. %, N, 7.0 wt. % 0, 54.98 wt. % Zn, 19.24 wt. % S, and 3.74 wt. % Ti. The contained C and N atoms are from polydopamine. The XRD patterns (FIG. 7D) were used to verify that the synthesized particles contained ZnS and TiO₂. The XRD of known samples of Zn and TiO₂ were compared to the XRD of TiO₂—ZnS@PDA. The XRD of TiO₂—ZnS@PDA contained all peaks of ZnS and TiO₂. Thus, the prepared product contained ZnS and TiO₂. PDA did not exhibit a peak due to its amorphous structure.

### Example 3

### Preparation of TiO₂—ZnS@CPDA@rGO Film

Preparation of TiO₂—ZnS@PDA@rGO Film.

GO (0.06 g) was dispersed in of H₂O (20 ml), and then added TiO₂—ZnS@PDA (0.16 g) and dispersed by mechanical stirrer (10000 rpm). Then filtered under vacuum to get TiO₂—ZnS@PDA@GO composite film. The resulted film was heat from room temperature to 200° C. at 2° C./min under N2 (200 mL/min) and kept for 60 min, then heated to 800° C. at 5° C./min and kept for 1 hour. After the heating cycle was complete, the furnace was allowed to cool down naturally to room temperature.

Characterization.

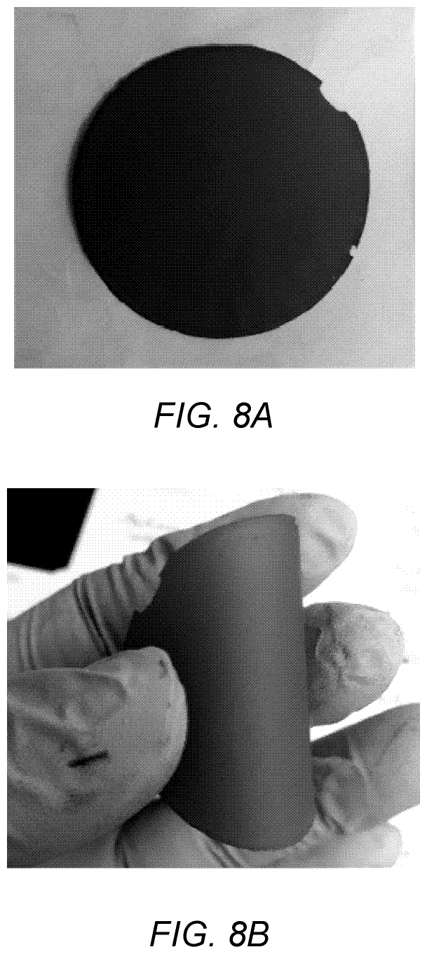

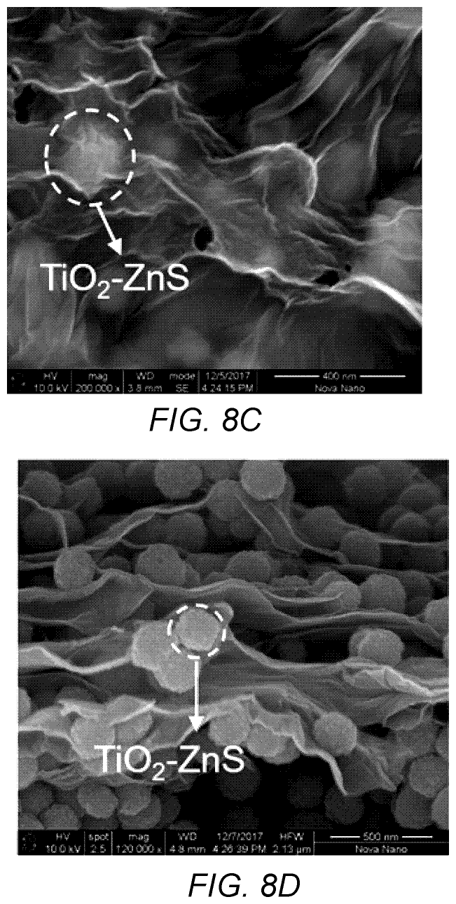

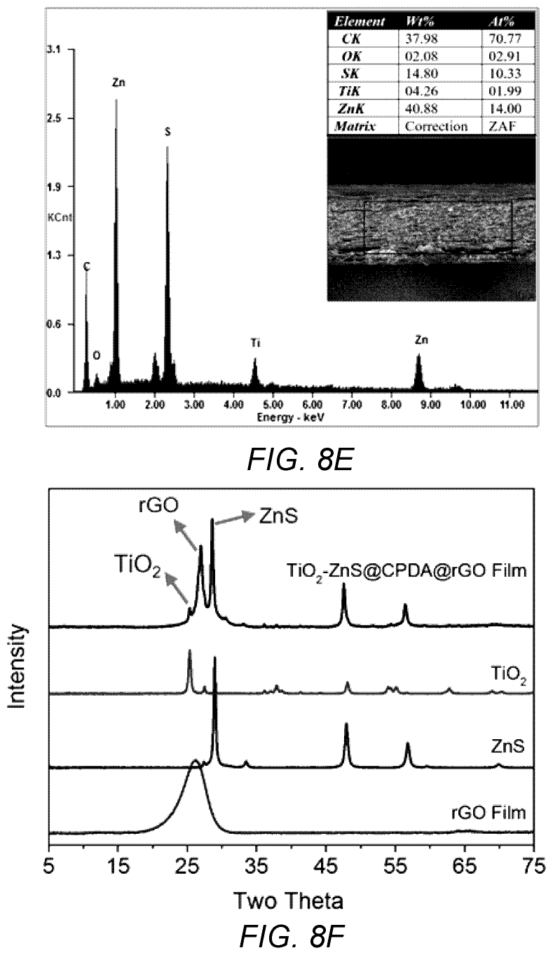

FIGS. 8A and 8B show the optical image of TiO₂—ZnS@CPDA@rGO film. From the magnified SEM top view (FIG. 8C) and magnified cross-section view (FIG. 8D) of the TiO₂—ZnS@CPDA@rGO film, it was determined that the films were flexible. It was observed from the SEMs that TiO₂—ZnS@CPDA particles were encapsulated by rGO (reduced graphene oxide) film. Further as shown in FIG. 8D, the layered rGO sheet is present and the TiO₂—ZnS@CPDA particles are sandwiched between rGO sheets.

FIG. 8E is the EDX of TiO₂—ZnS@CPDA@rGO film, which confirmed that the film contained C, O, S, Ti and Zn elements. Table 1 lists the EDX elements, wt. % and atomic %.

TABLE 1

| Element | Wt. % | At. % |
|---|---|---|
| CK | 37.98 | 70.77 |
| OK | 2.08 | 2.91 |
| SK | 14.80 | 10.33 |
| TiK | 4.26 | 1.99 |
| ZnK | 40.88 | 14.00 |

The components of this film were further confirmed through XRD. FIG. 8F shows the XRD patterns of rGO film, ZnS, TiO₂ and TiO₂—ZnS@CPDA@rGO film. It can be seen that the characteristic peaks of rGO, ZnS and TiO₂ appear in TiO₂—ZnS@CPDA@rGO film.

### Example 4

### Preparation of Multi-Layered Graphene Material Having a Plurality of Yolk/Shell Structures

Preparation of TiO₂—S@CPDA@rGO Film:

The obtained TiO₂—ZnS@CPDA@rGO film of Example 3 was mixed with an aqueous ferric nitrate solution (20 mL, 2 M, Sigma-Aldrich®, U.S.A.). The film was held in an ice-water bath for 15 hours with stirring, and then washed with water for three times. Hydrochloric acid was added to remove any remaining zinc sulfide. The resulting film was washed several times in deionized water again, and then dried in an oven at 60° C. for 3 hours under vacuum.

Characterization.

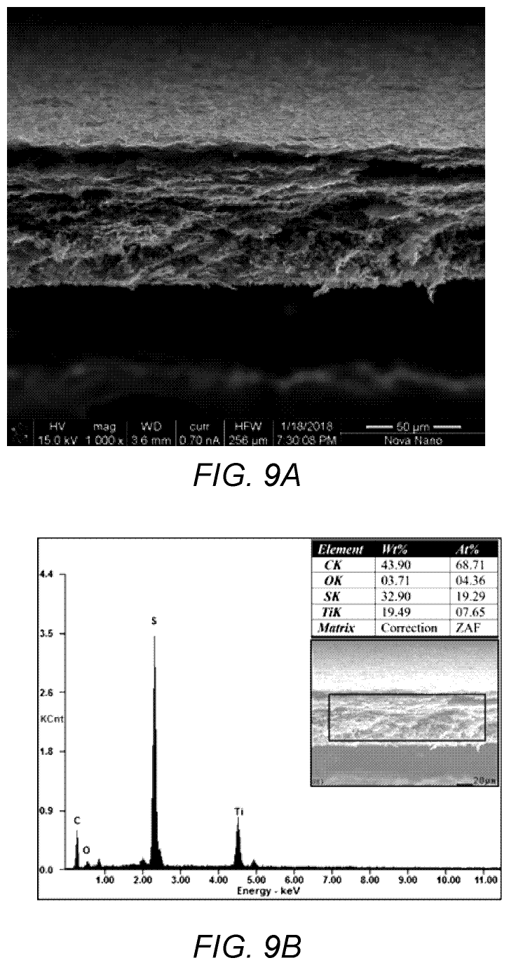

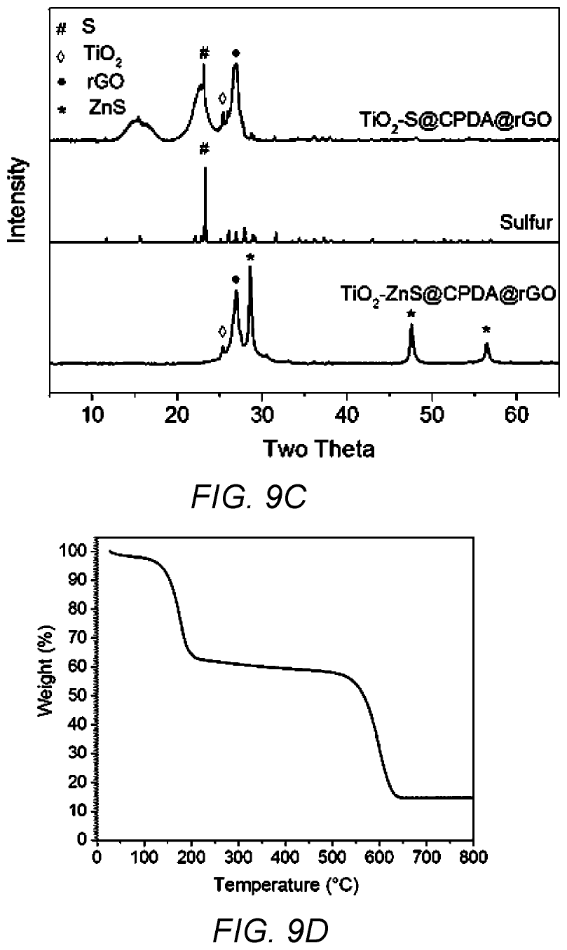

FIG. 9A shows the SEM cross-section view of TiO₂—S@CPDA@rGO film. FIG. 9B shows the EDX analysis, which confirmed that the film contained C, S, Ti and O atoms except Zn. Thus, the ZnS was converted into sulfur via oxidation by Fe(NO₃)₃. Table 2 lists the elements, wt. % and atomic %.

TABLE 2

| Element | Wt. % | At. % |
|---|---|---|
| CK | 43.9 | 68.71 |
| OK | 3.71 | 4.36 |
| SK | 32.90 | 19.29 |
| TiK | 19.49 | 7.65 |

Further confirmation of the components of the film was obtained using XRD. FIG. 9C shows XRD patterns of S, the TiO₂—ZnS@CPDA@rGO and the TiO₂—S@CPDA@rGO film. It can be seen that the characteristic peaks of S appear and those of ZnS disappear in TiO₂—S@CPDA@rGO film when compared with the XRD of TiO₂—ZnS@CPDA@rGO film. FIG. 9D is the TGA of TiO₂—S@CPDA@rGO film. From the TGA it was determined that the sulfur loading in the film was around 37 wt. %.

### Example 5

### Preparation of ZnS@CPAN@Al₂O₃@rGO Film

GO (0.1 g), ZnS (2 g having a size of 3-5 μm as determined by SEM), PAN (0.1 g) and fumed Al₂O₃ (0.02 g) were dispersed in of DMF (20 ml) using a mechanical stirrer (IKA Ultra-Turrax® T18, 10000 rpm) for 20 min. This mixture was filtered under vacuum to get the composite film (ZnS@PAN@Al₂O₃@GO) and then dried at 60° C. overnight. The resulted film was sandwiched between two graphite plates and loaded into a tubular furnace. The film was heated from room temperature 300° C. at 2° C./min and kept for 600 min under air (200 mL/min). After cooling down to room temperature, the film was heated from room temperature to 800° C. under nitrogen (200 mL/min) and kept for 30 min. After cooled down to room temperature, the composite film (ZnS@CPAN@Al₂O₃@rGO film) was obtained.

Characterization.

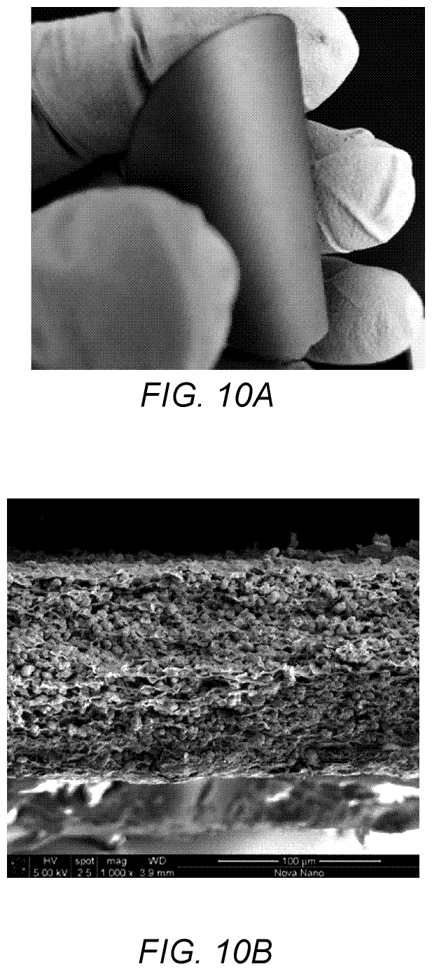

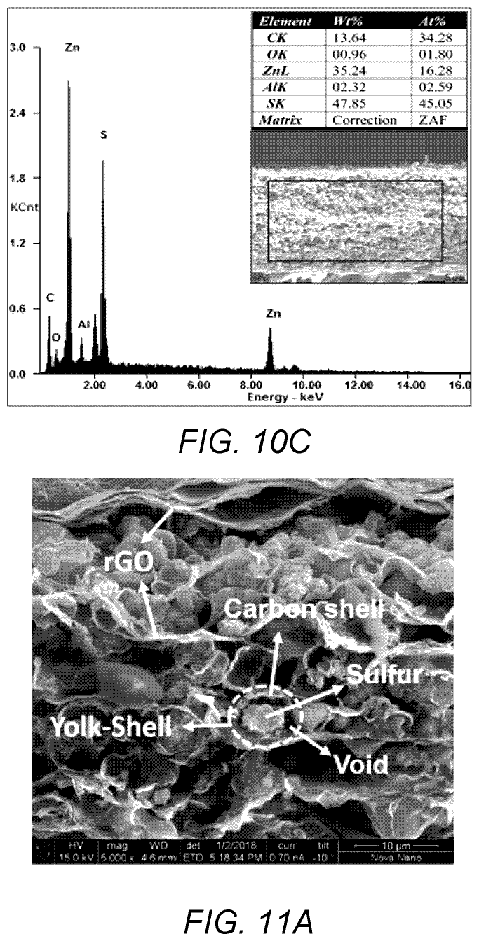

FIG. 10A is an optical image of ZnS@CPAN@Al₂O₃@rGO film, which shows that the film was flexible. FIG. 10B is the cross-section view of ZnS@CPAN@Al₂O₃@rGO film under SEM. From the SEM it was determined that the thickness of the film was about 124 μm. FIG. 10C shows the EDX analysis (FIG. 6d) shows the ZnS@CPAN@Al₂O₃@rGO film contains C, Zn, S, Al and O atoms. The contained C is from graphene oxide and polyacrylonitrile after calcination. The contained Zn and S atoms are from ZnS. Al atom is from Al₂O₃. O atom is from Al₂O₃ and graphene oxide. Table 3 lists the elements, wt. % and atomic %.

TABLE 3

| Element | Wt. % | At. % |
|---|---|---|
| CK | 13.64 | 34.28 |
| OK | 0.96 | 1.8 |
| ZnL | 35.24 | 16.28 |
| AlK | 2.32 | 2.59 |
| SK | 47.85 | 45.05 |

### Example 6

### Preparation of S@CPAN@Al₂O₃@rGO Film

The composite film (ZnS@CPAN@Al₂O₃@rGO) of Example 5 was mixed with an aqueous ferric nitrate solution (20 mL, 2 M) and held in an ice-water bath for 15 hours with stirring. The film was taken out and washed with water for 3 times then immersed in hydrochloric acid (20 mL, 2M) to remove any remaining zinc sulfide. Finally, the resulted film (S@CPAN@Al₂O₃@rGO) was washed 5 times by deionized water, and then dried in an oven at 60° C. for 3 hours under vacuum.

Characterization.

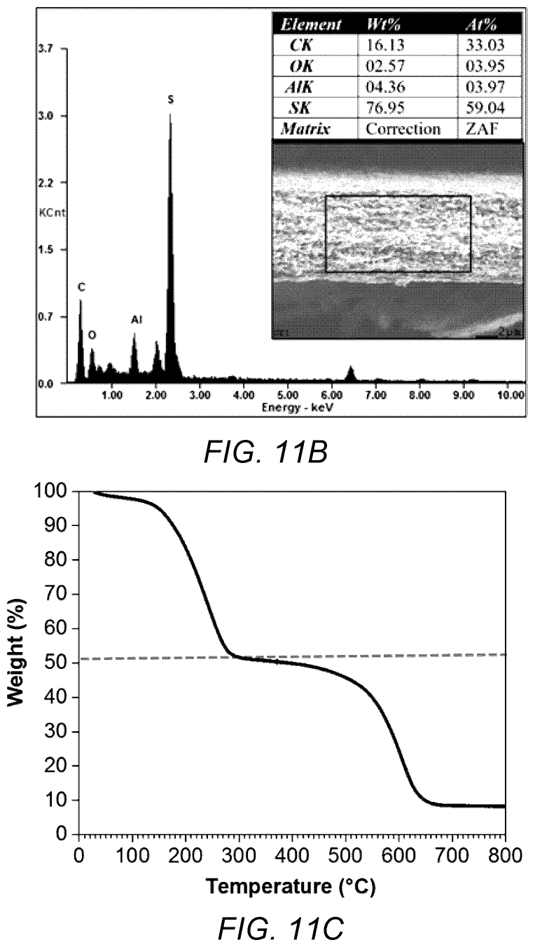

FIG. 11A shows the SEM image of cross-section view of S@CPAN@Al₂O₃@rGO film. From the SEM data, it was determined that the film included layered rGO with a carbon shell, yolk sulfur nanoparticle between the layers. In addition, a yolk-shell structure of sulfur core in carbon shell also can be observed. The EDX analysis (FIG. 11B) it was confirmed that the film contained C, S, Al and O atoms except Zn. Thus, ZnS was converted into sulfur via oxidation by Fe(NO₃)₃. Table 4 lists the elements, wt. % and atomic %. FIG. 11C shows the TGA of the S@CPAN@Al₂O₃@rGO film. From the TGA, it was determined that the sulfur loading was around 48 wt. %.

TABLE 4

| Element | Wt. % | At. % |
|---|---|---|
| CK | 16.13 | 33.03 |
| OK | 2.57 | 3.95 |
| AlK | 4.36 | 3.97 |
| SK | 76.95 | 59.04 |

1. A multi-layered graphene material comprising:
(a) at least two graphene layers that are attached to one another and have a plurality of spaces between the layers; and
(b) a plurality of yolk-shell structures positioned within the plurality of spaces between the layers, each yolk-shell structure comprising:
(i) a nano- or microstructure comprising elemental sulfur and a polysulfide trapping agent; and
(ii) a carbon-containing porous shell with an exterior surface and an interior surface that defines and encloses a hollow space within the interior of the shell, wherein the elemental sulfur nano- or microstructure is comprised in the hollow space,
wherein the plurality of spaces between the at least two graphene layers are configured to retain the plurality of yolk-shell structures.

2. The multi-layered graphene material of claim 1, wherein the carbon-containing porous shell is electrically conductive.

3. The multi-layered graphene material of claim 1, wherein the at least two graphene layers are attached to one another through a plurality of separate attachment points.

4. The multi-layered graphene material of claim 1, wherein the nano- or microstructure is an elemental sulfur and a polysulfide trapping agent composite material.

5. The multi-layered graphene material of claim 1, wherein an additional polysulfide trapping agent is embedded in the carbon-containing porous shell, in contact with the interior surface of the carbon-containing porous shell, comprised in the hollow space, in contact with the elemental sulfur nano- or microstructure, or any combination thereof.

6. The multi-layered graphene material of claim 1, wherein the polysulfide trapping agent is a metal oxide.

7. The multi-layered graphene material of claim 6, wherein metal oxide comprises MgO, Al₂O₃, CeO₂, La₂O₃, SnO₂, Ti₄O₇, TiO₂, MnO₂, or CaO, or any combination thereof.

8. The multi-layered graphene material of claim 7, wherein the metal oxide is TiO₂.

9. The multi-layered graphene material of claim 1, wherein the carbon-containing porous shell comprises nitrogen or a nitrogen containing compound.

10. The multi-layered graphene material of claim 1, wherein the hollow space allows for volume expansion of the elemental sulfur nano- or microstructure without deforming the porous shell structure.

11. The multi-layered graphene material of claim 1, wherein the multi-layered graphene material is binder-free.

12. The multi-layered graphene material of claim 1, wherein the material is in the form of a sheet or film.

13. An energy storage device comprising the multi-layered graphene material of any one of claim 1.

14. The energy storage device of claim 13, wherein the energy storage device is a rechargeable battery.

15. The energy storage device of claim 14, wherein the rechargeable battery is a lithium-ion or lithium-sulfur battery.

16. The energy storage device of claim 13, wherein the multi-layered graphene material is comprised in an electrode of the energy storage device.

17. A method of making the multi-layered graphene material of claim 1, the method comprising:
(a) forming a multi-layered graphene precursor material from composition comprising a plurality of graphene oxide layers or graphene and a plurality of metal sulfide containing nano- or microstructures comprising a carbon-containing organic polymer coating; or a composition comprising graphene oxide layers or graphene layers, a plurality of metal sulfide containing nano- or microstructures, and a carbon-containing organic polymer,
the multi-layered graphene the precursor material comprising:
(i) at least two graphene or graphene oxide layers that are attached to one another, wherein a plurality of spaces are present between the layers; and
(ii) a plurality of core-shell structures positioned within the plurality of spaces between the layers, each core-shell structure comprising:
one of the plurality of metal sulfide containing nano- or microstructures; and
a shell that encompasses the metal sulfide containing nano- or microstructure, the shell comprising the carbon-containing organic polymer;
(b) heat treating the multi-layered graphene precursor material to: (i) convert any graphene oxide layers to graphene; optionally (ii) form carbon-containing porous shells from the shells comprising the carbon-containing organic polymer precursor; and (iii) form at least one attachment point between the at least two graphene layers from the carbon-containing organic polymer; and
(c) subjecting the multi-layered graphene precursor material to conditions sufficient to oxidize the metal sulfide nano- or microstructures to form elemental sulfur nano- or microstructures comprised within hollow spaces of the carbon-containing porous shells,
wherein the multi-layered graphene material of any one of claim 1 is obtained.

18. The method of claim 17, wherein the metal sulfide containing nano- or microstructure further comprises metal oxide nano- or microstructures, or a metal oxide precursor material, and wherein the heat treating step (b) optionally comprises calcining the composition to convert the metal oxide precursor material to a metal oxide.

19. The method of claim 17, wherein the carbon containing organic polymer is polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof.

20. The method of claim 17, wherein the metal sulfide is ZnS, CuS, MnS, FeS, CoS, NiS, PbS, Ag₂S, or CdS, or any combination thereof.
